(19) United States
(12) Patent Application Publication
(10) Pub. No.: US 2026/0220373 A1
(43) Pub. Date: Jul. 30, 2026

(54) SYSTEM AND METHOD FOR AUTOMATICALLY IDENTIFYING THE ROLE AND ACCESS PROFILE OF A USER

(71) Applicant: Honeywell International Inc., Charlotte, NC (US)

(72) Inventors: Ankit Singh, Apex, NC (US); Timothy Sneed, Beachwood, NJ (US); Lakshminarayana Paila, Frisco, TX (US); Waad Subber, Schenectady, NY (US)

(21) Appl. No.: 19/038,715

(22) Filed: Jan. 28, 2025

(51) Int. Cl. G06F 40/30; G06F 40/205; H04L 67/306

(52) U.S. Cl. CPC G06F 40/30; G06F 40/205; H04L 67/306

(57) ABSTRACT

The present disclosure discloses a system implemented with an integrated web service platform for automatically identifying role and access profile of a user. The system utilizes the textual input to identify the role and access profile of the user across the web services that are integrated within the integrated web service platform. The textual input defines the desired role and access profile of one or more users. The system processes and analyses the textual input to identify the roles and access profiles that are required to be updated in configured roles and access profiles of the users in accordance with the textual inputs. According to an embodiment, the system uses natural language processing (NLP) techniques to identify the related keywords, from the textual inputs. The related keywords are then mapped with labels associated with the configured roles and access profiles of the users to select relevant labels for updating the role and access profile.

### FIELD OF INVENTION

The present disclosure generally relates to an integrated web service platform. More specifically, the present disclosure provides a system and a method for automatically identifying a user's role and access profile across web services provided by the integrated web service platform.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

An integrated web service platform facilitates integrating various applications, and web services in a single platform. The integrated web service platform typically includes tools for managing and developing web applications. Software as a Service (SaaS) is a well-known example of a software delivery model that operates within an integrated web service platform. In the context of SaaS, the integrated web service platform provides the infrastructure and resources necessary to deliver software applications to users over the Internet.

When using SaaS within an integrated web service platform, developers can leverage the platform's various components such as hosting, databases, user management, and security features to build, deploy, and manage the user's SaaS applications. Meanwhile, the users can conveniently access and utilize these applications through their web browsers without requiring local installation.

The integrated web service platform also offers a centralized environment for managing the various web services, including monitoring performance, scaling resources, and implementing security measures while offering seamless integration between different SaaS tools such as cloud data management tools and business intelligence tools.

A system admin is generally responsible for configuring roles and access per user. Further, in a case when multiple web services are integrated into a single application platform then the system admin has to configure the roles and access per user multiple times for each web service. Now, when the system admin is required to tailor the roles and access profiles of any users in order to fulfill specific requirements, then in such a case, the system admin either has to manually customize the roles and/or access of each user or go for completely redefining the framework of the software platform.

Consider the scenario where the platform integrates multiple web services, such as data analytics, laboratory information management, equipment monitoring, and regulatory compliance tracking. Further, the system admin may tasked with configuring user roles and access permissions across these integrated web services, ensuring that different users can be mapped for various roles such as review project manager, business admin, approver, analysts, and compliance officers, and can have the appropriate access based on their roles and responsibilities.

For example, user A is required to be mapped for a business admin role with a specified set of access across the web services provided in the integrated service platform. Accordingly, the system admin would need to configure roles and access permissions for user A within each web service in the integrated service platform separately and manually, which can be time-consuming and prone to inconsistencies. Further, in a case where the system admin is required to customize the roles and access profile of user A, the system admin is required to manually customize the roles. Thus, such traditional solutions are inefficient and lead to errors.

Thus, there is a need to provide a system and a method to mitigate the above-mentioned issues related to the mapping of roles and access profiles of the users in the integrated web service environment.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a solution for automatically identifying the role and access profile of a user. Other implementations will be or will become, apparent to one with skill in the art upon examination of the following figures and detailed description. It is intended that all such additional implementations be included within this description within the scope of the disclosure.

In one embodiment, the present disclosure discloses a method for automatically identifying the role and access profile of a user based on a textual query. The method includes configuring a first set of labels, said first set of labels indicates a role assigned to one or more users, and each first label is associated with a first feature vector. Further, the method includes configuring a second set of labels, the second set of labels defines the access profile, and each second label is associated with a second feature vector. Further, the method includes mapping each of the second set of labels with one or more first set of labels. In an embodiment, the method includes receiving an input, said input being a textual input defining the desired role and access profile of one or more users. Further, the method includes processing the textual input to parse one or more keywords and define the vector representation of the one or more keywords. Further, the method includes performing a semantic analysis on the one or more keywords, to determine a contextual relationship between the one or more keywords. Further, the method includes identifying at least one first keyword, from the one or more keywords, which has a vector similarity with at least one first set of labels. Further, the method includes identifying at least one second keyword, from the one or more keywords, which has the vector similarity to the at least one or more second set of labels associated with the first set of labels. Further, the method includes selecting the first set of labels and the second set of labels associated with the first set of labels based on the contextual relationship and updating the profile of the one or more users to identify the role and access profile based on the selected first set of labels and one or more second set of labels.

According to some embodiment, the present disclosure discloses a system for automatically identifying the role and access profile of a user based on a textual query. The system includes one or more processors, the memory, and one or more programs stored in the memory. In an embodiment, the one or more programs when executed by the one or more processors, cause the one or more processors to configure a first set of labels, said first set of labels indicates a role assigned to one or more users, and each first label is associated with a first feature vector. Further, the one or more processors are configured to configure a second set of labels, the second set of labels defines the access profile and each second label is associated with a second feature vector. Further, the one or more processors are configured to map each of the second set of labels with one or more first set of labels. Further, the one or more processors are configured to receive an input, said input being a textual input defining the desired role and access profile of one or more users. Further, the one or more processors are configured to process the textual input to parse one or more keywords and define vector representation of the one or more keywords. Further, the one or more processors are configured to perform a semantic analysis on the one or more keywords, to determine a contextual relationship between the one or more keywords. Further, the one or more processors are configured to identify at least one first keyword, from the one or more keywords, which has a vector similarity with at least one first set of labels. Further, the one or more processors are configured to identify at least one second keyword, from the one or more keywords, which has the vector similarity to the at least one or more second set of labels associated with the first set of labels. Further, the one or more processors are configured to select the first set of labels and the second set of labels associated with the first set of labels based on the contextual relationship and update the profile of the one or more users to identify the role and access profile based on the selected first set of labels and one or more second set of labels.

According to some embodiment, the present disclosure discloses a non-transitory computer-readable storage medium storing program instructions for automatically identifying the role and access profile of a user based on a textual query. According to an embodiment, the instructions when executed, perform the steps of configuring a first set of labels, said first set of labels indicates a role assigned to one or more users, and each first label is associated with a first feature vector. The non-transitory computer-readable storage medium further performs configuring a second set of labels, the second set of labels defines the access profile, and each second label is associated with a second feature vector. Further, the non-transitory computer-readable storage medium performs mapping each of the second set of labels with one or more first set of labels. Further, the non-transitory computer-readable storage medium performs receiving an input, said input being a textual input defining the desired role and access profile of one or more users. Further, the non-transitory computer-readable storage medium performs processing the textual input to parse one or more keywords and define vector representation of the one or more keywords. Further, the non-transitory computer-readable storage medium performs a semantic analysis on the one or more keywords, to determine a contextual relationship between the one or more keywords. Further, the non-transitory computer-readable storage medium performs identifying at least one first keyword, from the one or more keywords, which has a vector similarity with at least one first set of labels. Further, the non-transitory computer-readable storage medium identifies at least one second keyword, from the one or more keywords, which has the vector similarity to the at least one or more second set of labels associated with the first set of labels. Further, the non-transitory computer-readable storage medium performs selecting the first set of labels and the second set of labels associated with the first set of labels based on the contextual relationship and updating the profile of the one or more users to identify the role and access profile based on the selected first set of labels and one or more second set of labels.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example environment of a system for automatically identifying the role and access profile of a user based on a textual query, according to an embodiment of the present disclosure;

FIG. 2 illustrates an example block diagram of the system depicted in FIG. 1, in accordance with an embodiment of the present disclosure;

FIG. 3 illustrates an example of a dashboard for assigning roles and access profiles to a user, according to an embodiment of the present disclosure;

FIG. 4 illustrates an example of a textual input that can be provided by a system admin, according to an embodiment of the present disclosure;

FIG. 5 illustrates a method for determining the contextual relationship between the keywords, according to an embodiment of the present disclosure;

FIG. 6 illustrates a method for identifying the keywords having vector similarity with the set of labels, according to an embodiment of the present disclosure;

FIG. 7 illustrates an example of a user interface (UI) for assigning users with desired roles and access profiles, according to an embodiment of the present disclosure;

FIG. 8 illustrates a method for automatically identifying the role and access profile of a user based on a textual query, according to an embodiment of the present disclosure; and

FIG. 9 illustrates a general block diagram of the system, according to an embodiment of the present disclosure.

### DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

In one embodiment, the present disclosure discloses a system implemented with an integrated web service platform for automatically identifying the role and access profile of a user. More particularly, the system utilizes the textual input to identify the role and access profile of the user across the web services that are integrated within the integrated web service platform. The textual input defines the desired role and access profile of one or more users.

According to an embodiment, the system processes and analyses the textual input to identify the roles and access profiles that are required to be updated in configured roles and access profiles of the users in accordance with the textual inputs. According to an embodiment, the system uses natural language processing (NLP) techniques to identify the related keywords, from the textual inputs. The related keywords are then mapped with labels associated with the configured roles and access profiles of the users to select relevant labels for updating the role and access profile.

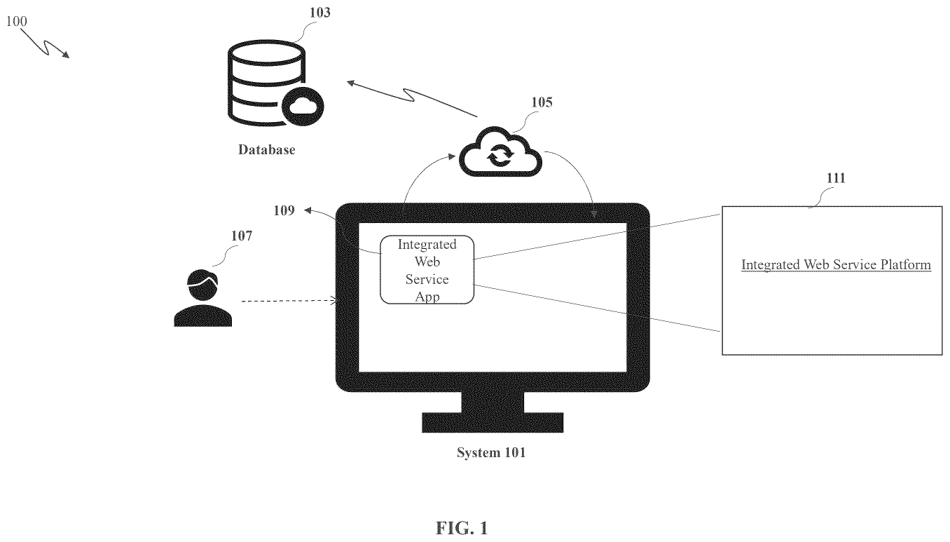

FIG. 1 illustrates an example environment of a system for automatically identifying the role and access profile of a user based on a textual query, according to an embodiment of the present disclosure. According to an embodiment, FIG. 1 depicts an environment 100 that includes a system 101 coupled with a database 103. In a non-limiting example, the system 101 may be a computer, a laptop, a smartphone, a server, or any electronic machine.

In an embodiment, the database 103 may be implemented in the system 101 or virtually implemented in a cloud server 105. According to an embodiment, the system 101 is implemented with an integrated web service platform that can be accessed through an integrated web service application (APP) 109. In an embodiment, the integrated web service application App 109, when operated by a system admin 107, renders an integrated web service platform 111 via a user interface (UI). In an embodiment, the integrated web service platform 111 is a comprehensive application that integrates one or more web services in a single platform and automatically identifies a user's role and access profile based on the textual inputs. The system 101 intuitively identifies a user's role and access profile based on the textual inputs and renders it on a single screen for the system admin 107. Thus, it is easier to map a subset of permissions per user for one or more web services and display them for the system admin 107 on a single screen rather than repeatedly moving on multiple screens. Various advantages and technical effects can be envisaged from the forthcoming

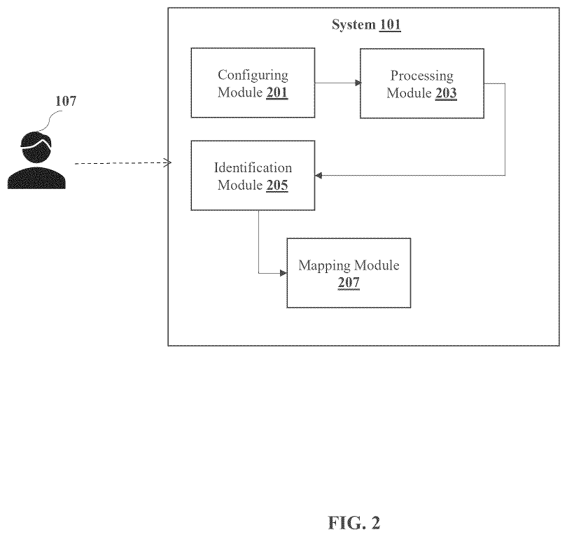

FIG. 2 illustrates an example block diagram of the system depicted in FIG. 1, in accordance with an embodiment of the present disclosure. According to an embodiment, the system 101 includes a configuring module 201, a processing module 203, an identification module 205, and a mapping module 207, which are operatively coupled with each other. According to one or more embodiments, the configuring module 201, the processing module 203, the identification module 205, and the mapping module 207 are uniquely designed hardware modules or software modules.

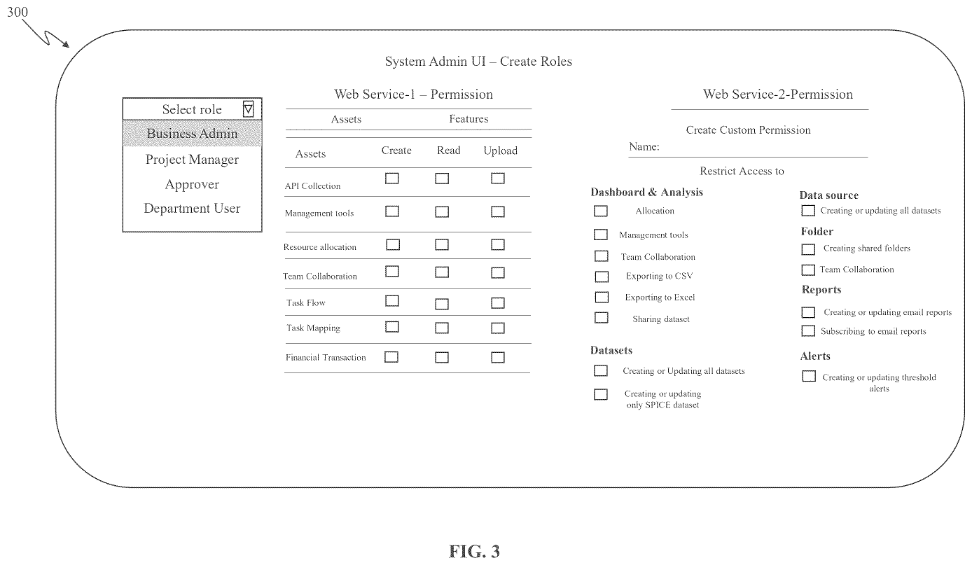

According to some embodiments, functions of the configuring module 201, the processing module 203, the identification module 205, and the mapping module 207 can be performed by the processor(s). Further, according to some embodiment, the configuring module 201, the processing module 203, the identification module 205, and the mapping module 207 are integrated with the integrated web service platform 111. Further, an explanation will be made by referring to modules depicted in FIG. 2. Furthermore, the labels depicted in the representative drawings are kept the same for similar components throughout the disclosure for ease of understanding. The working of each module as depicted in FIG. 2 will be explained in detail in the forthcoming paragraphs through the drawings FIGS. 3 to 7.

According to an embodiment, the system admin 107 may provide input for assigning roles and access profiles to one or more users. For example, consider a scenario where the user role and access profile will be assigned in the integrated web service platform 111 by the system admin 107. In an exemplary scenario, consider that User X is the system admin for a large SaaS platform which is an integrated web service platform used by a company called Y. The platform provides various tools and features based on user roles and access profiles. As part of their responsibilities, User X needs to assign roles and access profiles to new employees and make changes for existing employees as their job roles evolve. In this scenario, a new employee, User A, has joined company Y as a Business Admin. Based on the predefined conditions set by the company's Information Technology (IT) and security policies, specific roles and access profiles need to be assigned to User A. In an exemplary scenario, consider the following predefined conditions set by company Y.

### Conditions:

The Business Admin is granted access to management tools, resource allocation modules, and team collaboration features.
Business Admin should have access to financial records or customer support systems.
Business Admin should not have access to perform financial transactions.

According to an example embodiment, User X, the system admin, may log into the SaaS platform's admin dashboard and navigate to the create role section. The system admin selects first the Business Admin profile and initiates the process of assigning roles and access profiles.

FIG. 3 illustrates an example of a dashboard 300 for assigning roles and access profiles to a user, according to an embodiment of the present disclosure. According to an embodiment, the dashboard 300 is the UI for the system admin 107 for assigning roles and access profiles for the users. In an embodiment, the dashboard 300 provides a functionality to assign roles and access permission for one or more web services over a single screen. For example, as shown in FIG. 3, the system admin 107 can assign roles and access profiles for Web Service 1 and Web Service 2.

According to an example embodiment, based on the predefined conditions as described above, the system admin 107 selects the “Business Admin” role from a list of available roles within the platform. This role is configured to provide access to management tools, resource allocation modules, and team collaboration features, financial records, customer support systems and will not have access to perform financial transactions ensuring that User A will have the necessary capabilities to fulfill their responsibilities.

In an implementation, as the system admin 107 assigns roles and access profiles through dashboard 300, at the backend the configuring module 201 configures a set of labels where each set of labels is associated with respective feature vectors. In embodiment, a first set of labels indicates a role assigned to one or more users and a second set of labels defines access profile. Further, the respective feature vectors of the set of labels can be obtained using techniques like pre-trained word embeddings and language models.

Referring to the example scenario of FIG. 3, the first set of labels will indicate labels for the Business Admin role and the second set of labels will indicate labels for the access profile like access to management tools, resource allocation modules, team collaboration features, financial records, customer support systems but will not have access to perform financial transactions for the Business Admin role. Accordingly, the first labels for the Business admin role can be configured as below:

$$First set of labels = [ Business Administrator , Admin , Business Operations , Managment , Business Support ] \qquad ( 1 )$$

Further, the second set of labels can be configured as below:

$$Second set of labels = [ Management Tools ; Resource Allocation , Team Collaboration , Financial Records Viewer , Customer Support Systems , No Financial Transactions ] \qquad ( 2 )$$

Further, the configuring module 201 maps each of the second set of labels with the first set of labels. In particular, the configuring module 201 establishes relationships between elements from one set to elements in another set. The configuring module 201 determines a similarity score using techniques such as cosine similarity or Euclidean distance to measure the similarity between the feature vectors representing the first set of labels and the second set of labels. Thus, the label from the first set with the highest similarity is then mapped to the label from the second set.

For example, the label “Management Tools” from the second set of labels might have a high similarity with the “Business Administrator” and “Management” labels from the first set of labels, indicating that users with the business admin role should have access to management tools. Similarly, “Financial Records” might be mapped to “Business Administrator” and “Management” roles, signifying that users with these roles should have access to view financial records. According to an embodiment, the configuring module 201 may be implemented with AI/ML models for using techniques like pre-trained word embeddings and language models.

Thus, the configuring module 201 configures the roles and access profile based on the system admin input and the predefined conditions and rules. However, as discussed in the background section, in the scenario when the system admin is required to tailor the user's role or access profiles, the system admin has to configure the roles and access per user multiple times for each web service. In order to efficiently and automatically identify the role and access profile of the user, the system admin 107 may provide the textual input that defines the user's desired role and access profile.

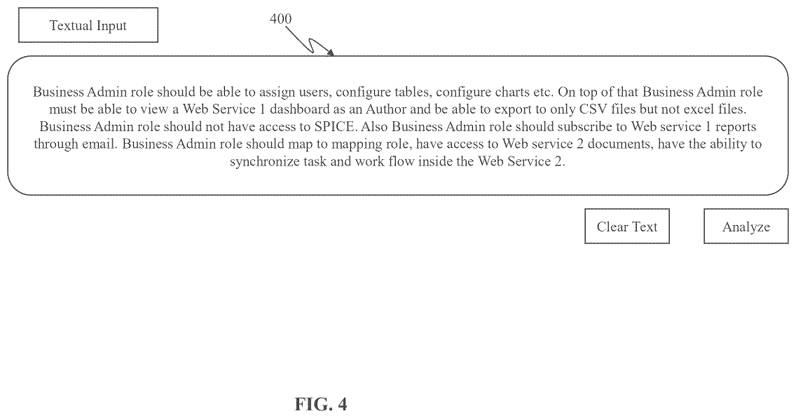

FIG. 4 illustrates an example of a textual input 400 that can be provided by a system admin 107, according to an embodiment of the present disclosure. According to the example embodiment, the desired role and access profile of the Business Admin can be summarized below:
Assign User Roles:
   Business Admin can assign user roles within the system.
Configuration:
   Business Admin can configure tables, charts, and other settings as needed.
Web Service 1 Dashboard:
   Business Admin can view the Web Service 1 dashboard as an Author.
   Can only export data to CSV files, not Excel files.
Access Restrictions:
   Business Admin does not have access to SPICE.
Report Subscription:
   Business Admin can subscribe to Web Service 1 reports and receive them via email.
Mapping:
   The Business Admin role is mapped to the mapping role.
   Has access to Web Service 2 documents.
Task Management:
   Can synchronize tasks and workflows within Web Service 2.

According to an embodiment, the system admin can customize the role by providing the textual input. The textual input may define the role as having specific capabilities and restrictions.

According to an embodiment, the processing module 203 receives the textual input defining the desired role and access profile of one or more users. Further, the processing module 203 processes the textual input to parse one or more keywords and define vector representation of the one or more keywords. Further, the processing module 203 performs a semantic analysis on the one or more keywords, to determine a contextual relationship between the one or more keywords.

According to an embodiment, to process the textual input to parse keywords and define vector representations of these keywords, the processing module 203 breaks down the input text into individual words or tokens. Further, the processing module 203 filters the unwanted words (e.g., ‘a’, ‘the’, ‘should’) from the textual input that are not significant according to the context. Further, the processing module 203 normalizes the words to ensure variations of the same word are treated as the same keyword. Further, the processing module 203 performs keyword extraction using natural language processing techniques to identify and extract important keywords or phrases from the textual input. In embodiment, the processing module 203 converts the extracted keywords into vector representations using techniques like word embeddings, pre-trained language models, and the like.

Considering the textual input 400 as shown in FIG. 4, the processing of the textual input 400 can provide the keywords for example, “Business Admin role, assign user, configure tables, configure charts, Web Service 1 dashboard, Author, export CSV files, Web Service 2 documents, synchronize task, workflow, SPICE, subscribe, reports, mapping role, access.” Further, the “Business Admin role” could be represented as a vector in a high-dimensional space capturing its semantic meaning.

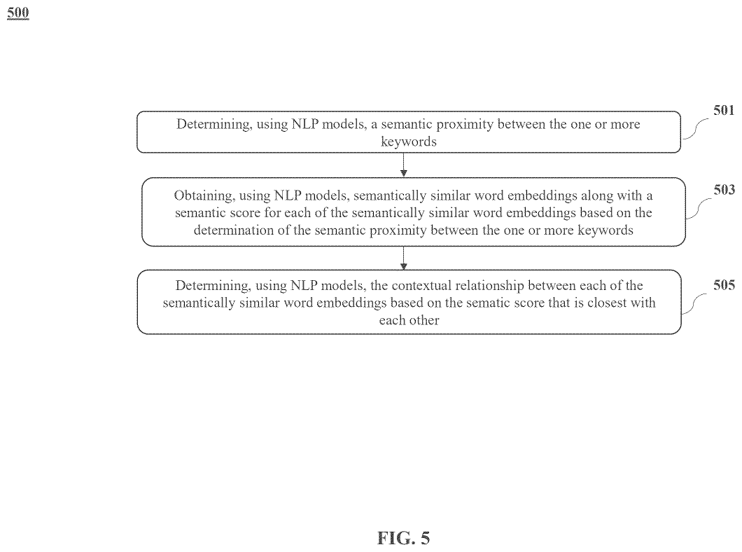

In an embodiment, the processing module 203 further performs semantic analysis on parsed keywords, to determine a contextual relationship between the keywords. FIG. 5 illustrates a method for determining the contextual relationship between the keywords, according to an embodiment of the present disclosure. In an embodiment, the method 500 is performed by the processing module 203. According to an embodiment, the processing module 203 is implemented with NLP models.

According to an embodiment, the processing module 203, at step 501, determines a semantic proximity between the keywords. The semantic proximity refers to the closeness in meaning between the keywords. In an embodiment, the semantic proximity between the extracted keywords is assessed to understand how closely the keywords are related, using techniques such as cosine similarity or Euclidean distance to measure the similarity. According to the example of FIG. 4 the semantic proximity between key roles and responsibilities related to the Business Admin role, can be obtained as “Assign users,” “Configure tables,” “Web Service 1 dashboard,” “Export CSV files,” “Subscribe to reports,” etc. In another example, the semantic proximity analyses how closely “Assign users” is related to “Configure tables” or how similar “Web Service 1 dashboard” is related to “Export CSV files” in terms of their meaning and context with respect to the Business Admin role.

Further, at step 503, the processing module 203 obtains semantically similar word embeddings and a semantic score for each semantically similar word embeddings. In an implementation, the processing module 203, the NLP model represents each keyword as a word embedding. The word embeddings capture its semantic meaning in a high-dimensional vector space. By obtaining the word embeddings for the keywords, the processing module 203 captures the contextual and semantic information in the keywords. Further, the processing module 203 calculates the semantic score for each keyword by using techniques like cosine similarity and the like. The semantic score quantifies the semantic proximity between the keywords thereby providing a measure of their similarity in meaning. For example, the semantic score between “Assign users” and “Configure tables” indicates how closely these actions are related in the context of the provided textual input. According to another example, the semantic score may determine how semantically similar tasks like “Assign users” and “Configure tables” are within the context of the Business Admin's duties.

Further, at step 505, the processing module 203 determines the contextual relationship between each of the semantically similar word embeddings based on the semantic score that is closest to each other. For example, the contextual relationship establishes the context between tasks like “Web Service 1 dashboard access” and “Subscription to reports” within the role's responsibilities of the Business Admin.

According to some embodiment, the contextual relationship may be determined based on the user's historical data. In a non-limiting example, the user's historical data includes at least one of the user selection patterns and the user's behavior. In an embodiment, the user can be the system admin. For example, the processing module 203 may determine the contextual relationship by considering parameters like the frequency of user assignments, typical configurations made to tables and charts, preferred dashboards accessed, frequency of report subscriptions, task synchronization patterns, previous actions taken by the business admins and the like. In an embodiment, the system 101 monitors the system admin and other roles of the integrated platform and stores it as the user's historical data in the database. The processing module 203 acquires the user's historical data from the databases and utilizes it for the determination of the contextual relationship.

Moving further, according to an embodiment, the identification module 205, identifies the one or more keywords from the parsed keywords such that the identified keywords have a vector similarity with the first set of labels and the second set of labels. For example, the identification module 205 identifies at least one first keyword, from the one or more keywords, which has the vector similarity with at least one first set of labels. Similarly, the identification module 205 identifies at least one second keyword, from the one or more keywords, which has the vector similarity to the at least one or more second sets of labels associated with the identified first set of labels. The identification of the keywords from the parsed keywords and the contextual relationship further aids in effectively selecting the closest labels from the first set of labels and the second set of labels.

Considering the example of FIG. 4, the identification module 205 identifies the first keywords related to the “Business Admin role” that is similar to the first set of labels (as given in expression 1 above) including “Business Administrator, Admin, Business Operations, Management, and Business Support.” Similarly, the identification module 205 identifies the second keywords related to the context of access profiles to the “Business Admin role” and is related to the second set of labels (as given in expression 2 above) including “Management Tools, Resource Allocation, Team Collaboration, Financial Records Viewer, Customer Support Systems, No Financial Transactions”.

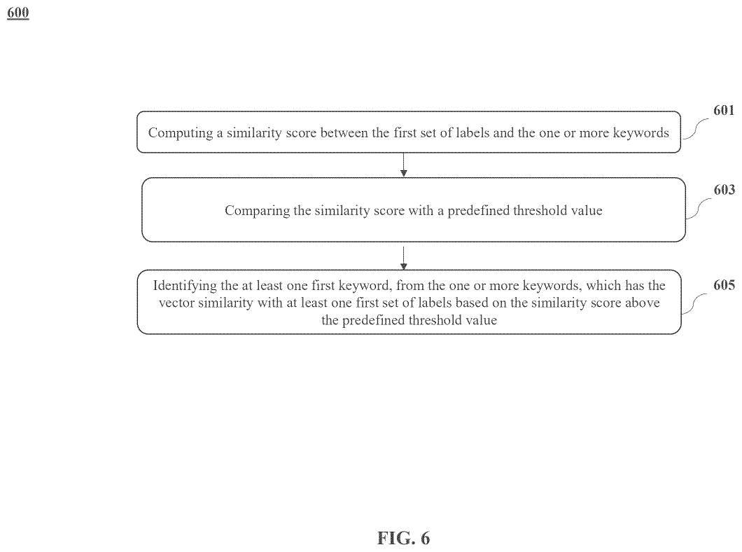

FIG. 6 illustrates a method for identifying the keywords having vector similarity with the set of labels, according to an embodiment of the present disclosure. Method 600 depicts a method for identifying the first keywords from the one or more keywords which has the vector similarity with at least one first set of labels.

According to an embodiment, at step 601, the identification module 205 computes a similarity score between the first set of labels and the one or more keywords using the NLP models. As an example, techniques like cosine similarity or Euclidean distance can be used to determine similarity between the feature vectors associated with the first set of labels and the one or more keywords. Based on the similarity the similarity score is computed. Further, at step 603, the identification module 205 compares the similarity score with a predefined threshold value. Further, at step 605, the identification module 205 identifies the at least one first keyword, from the one or more keywords, which has the vector similarity with at least one first set of labels based on the similarity score above the predefined threshold value.

In an embodiment, for identifying the second keywords from the one or more keywords which has the vector similarity with the second set of labels, the identification module 205 performs similar method steps as that of method 600. Therefore, a detailed explanation of the step is omitted here for the sake of brevity.

In an embodiment, for identifying the second keywords from the one or more keywords, the identification module 205 computes a similarity score between the second set of labels and the one or more keywords. Further, the identification module 205 compares the similarity score with a predefined threshold value. Further, the identification module 205 identifies the at least one second keyword, from the one or more keywords, which has the vector similarity with at least one second set of labels based on the similarity score above the predefined threshold value.

In a non-limiting example, for the label “Business Administrator”, the identified keyword can be “Business Admin role” as the keyword “Business Admin role” will have high vector similarity with the keyword “Business Administrator.” Similarly, for the label “Admin” the identified keyword can be “assign user” as the keywords may have a close contextual association. In a further example, for the label “Business Operations”, the identified keyword can be “workflow” as there is a semantic connection between them. Further, for label management, “Management” the identified keyword can be “configure tables.” Similarly, for the label “resource allocation” the identified keyword can be “assign user.”

According to a further embodiment, the mapping module 207 maps identified keywords with the first set of labels and the second set of labels based on the determined contextual relationship. In a non-limiting example, the identified keyword “Business Admin role” can be mapped with the label “Business Administrator.” In another example, the identified keyword “assign user” can be mapped with “team collaboration.” Further, the “configure chart” can be mapped with “resource allocation’ and the like.

According to an embodiment, the mapping module 207, further selects labels from the first set of labels and the second set of labels associated with the first set of labels based on the contextual relationship. In an embodiment, the first set of labels and the second set of labels are mapped with the keywords identified from the textual input, the mapping module 207 appropriately selects labels that align semantically with the textual input provided by the system admin based on the contextual relationship. Accordingly, in a scenario where the textual input consists of keywords like “Business Admin” defining the desired roles and access profile of the user, the mapping module 207 efficiently updates the profile of the one or more users to identify the role and access profile across the web services or applications provided by the integrated web service platform. According to an embodiment, the system 101 may provide a recommendation regarding updating of the profile of the one or more users with the identified role and the access profile selections.

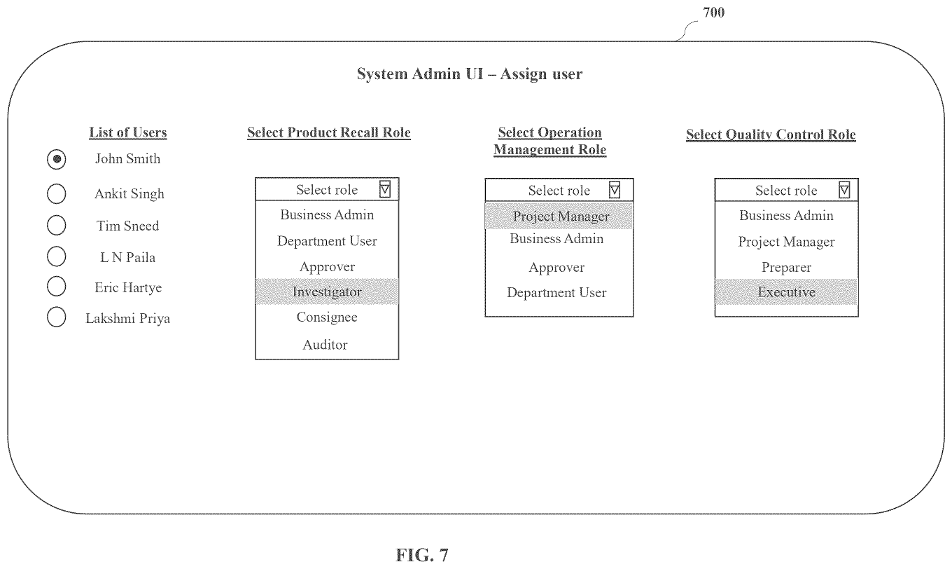

FIG. 7 illustrates an example of a user interface (UI) for assigning users with desired roles and access profiles, according to an embodiment of the present disclosure. According to an example embodiment, the UI 700 depicts the user interface for assigning users with desired roles and access profiles. According to an example scenario, consider that the system admin 107 desired to map various roles and access profiles for the user ‘John Smith’ across web services. In the example embodiment, the ‘John Smith’ is assigned with an ‘investigator’ role under the ‘select product recall role’. Further, ‘John Smith’ is assigned with ‘project manager’ role under the ‘select operation management role’, and ‘John Smith’ is further assigned with ‘executive’ role under the ‘select quality control role’. According to an embodiment, the system 101, provides a single user interface for assigning multiple roles to a single user. Further, the system admin can provide the textual input defining the desired roles and access profile, and thereby the system 101 automatically updates the profile of the ‘John Smith’ based on methodology as explained above with respect to the modules.

According to embodiment, the system admin 207 can manage the UI to display which permissions to show or expose to the respective user. Thus, it is easier for the user to see what is allowed and what is not allowed.

According to some embodiment, an organization can have a non-functional requirement document defining the roles and access profiles. Further, the non-functional requirement document can be stored in the database. Thus, according to an embodiment, an input is received from the non-functional requirement document rather than textual inputs. The rest of the procedure remains the same and can be referred to through the working of the processing module 203, identification module 205, and the mapping module 207. Therefore, the explanation of the same is omitted here for the sake of brevity.

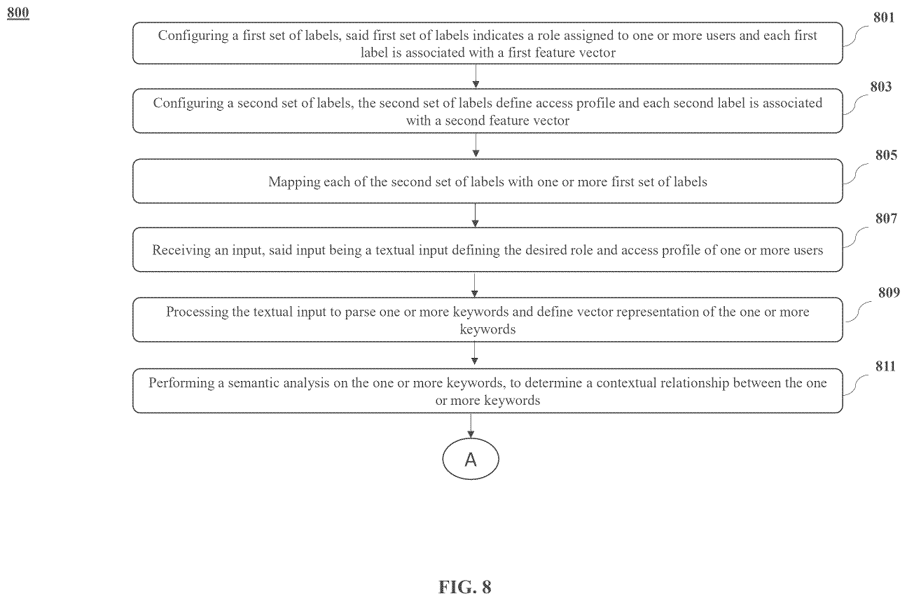

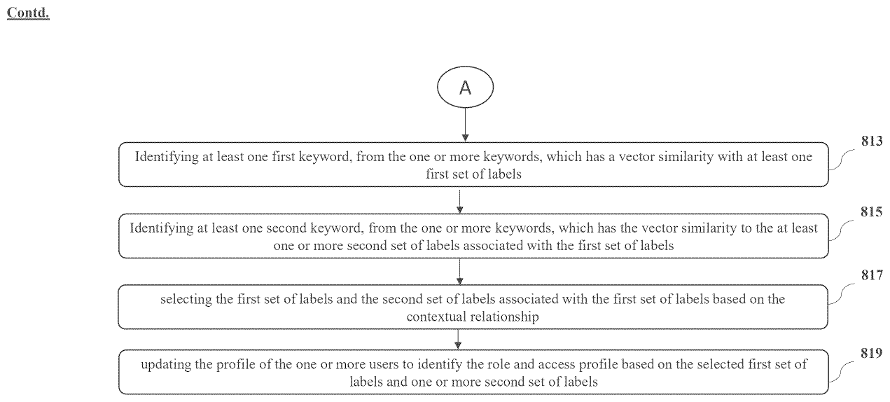

FIG. 8 illustrates a method for automatically identifying the role and access profile of a user based on a textual query, according to an embodiment of the present disclosure. In an embodiment, the method 800 is implemented on the system 101 of FIG. 1 and FIG. 2. A detailed explanation of the steps is explained through FIGS. 1-7, therefore the same is omitted here for the sake of brevity.

In an embodiment, the method 800, at step 801 includes configuring a first set of labels, said first set of labels indicates a role assigned to one or more users, and each first label is associated with a first feature vector. Further the method 800, at step 803, includes configuring a second set of labels, the second set of labels defines access profile and each second label is associated with a second feature vector. In an embodiment, the first set of labels is configured based on the user input, and the second set of labels is configured in accordance with predefined conditions and rules. Further, the method 800, at step 805, includes mapping each of the second set of labels with one or more first set of labels. In an embodiment, the steps 801, 803, and 805 are performed by the configuring module 201.

Further, the method 800, at step 807, includes receiving an input. The input is a textual input defining the desired role and access profile of one or more users. In an embodiment, the processing module 203 receives the textual input.

Further, the method 800, at step 809, includes processing the textual input to parse one or more keywords and define vector representation of the one or more keywords. Further, the method 800, at step 811, includes performing the semantic analysis on the one or more keywords, to determine the contextual relationship between the one or more keywords. In an embodiment, the semantic analysis is performed by the natural language processing (NLP) techniques.

In an embodiment, to determine the contextual relationship between the one or more keywords, the step 811, includes determining, using NLP models, the semantic proximity between the one or more keywords. Further, the step 811 includes obtaining, using NLP models, semantically similar word embeddings along with the semantic score for each of the semantically similar word embeddings based on the determination of the semantic proximity between the one or more keywords. Further, the step 811 includes determining, using NLP models, the contextual relationship between each of the semantically similar word embeddings based on the semantic score that is closest to each other.

According to some embodiment, the contextual relationship may be determined based on user's historical data acquired from the databases. As an example, the user's historical data includes at least one of the user selection patterns and user's behavior.

According to an embodiment, steps 807, 809, and 811 are performed by the processing module 203.

According to an embodiment, the method 800, at step 813, includes, identifying at least one first keyword, from the one or more keywords, which has a vector similarity with at least one first set of labels. According to an embodiment, the step 813 includes computing a similarity score between the first set of labels and the one or more keywords. Further, the step 813 includes comparing the similarity score with a predefined threshold value. Further, the step 813 includes identifying the at least one first keyword, from the one or more keywords, which has the vector similarity with at least one first set of labels based on the similarity score above the predefined threshold value.

According to an embodiment, the method 800, at step 815, includes, identifying at least one second keyword, from the one or more keywords, which has a vector similarity to the at least one or more second set of labels associated with the first set of labels. According to an embodiment, the step 815 includes computing a similarity score between the second set of labels and the one or more keywords. Further, the step 815 includes comparing the similarity score with a predefined threshold value. Further, the step 815 includes identifying the at least one second keyword, from the one or more keywords, which has the vector similarity with at least one second set of labels based on the similarity score above the predefined threshold value.

According to an embodiment, the steps 813 and 815 are performed by the identification module 205.

According to an embodiment, the method 800, at step 817, includes selecting labels from the first set of labels and the second set of labels associated with the first set of labels based on the contextual relationship. According to some embodiment, the labels are selected based on the identified first and the second keywords and the contextual relationship.

Further, the method 800, at step 819, includes updating the profile of the one or more users to identify the role and access profile based on the selected first set of labels and one or more second set of labels. The steps 817 and 819 are performed by the mapping module 207.

According to some embodiment, the method 800 further includes obtaining a non-functional requirement document from a plurality of databases. Further, the method 800 includes parsing the non-functional requirement document using NLP techniques. Further, the method 800 includes selecting the first set of labels and one or more second set of labels associated with the first set of labels based on a result of parsing the non-functional requirement document and updating the profile of the one or more users to identify the role and access profile selection of labels and second labels based on the selected first set of labels and one or more second set of labels.

According to an embodiment, the method 800 further includes providing a recommendation regarding updating of the profile of the one or more users with the identified role and the access profile.

The disclosed system and method improve the overall process related to the mapping of roles and access profiles of the users in the integrated web service environment by using textual input along with NLP models. The system intuitively identifies a user's role and access profile based on the textual inputs and renders it on a single screen for the system admin. Thus, it is easier to map a subset of permissions per user for one or more web services and display them for the system admin on a single screen rather than repeatedly moving on multiple screens.

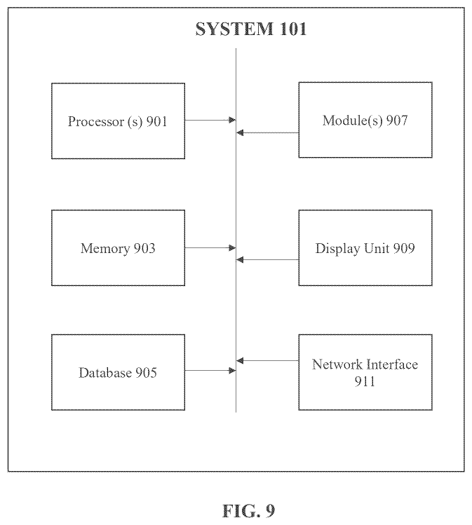

FIG. 9 illustrates a general block diagram of the system, according to an embodiment of the present disclosure.

In an example, the processor(s) 901 may be a single processing unit or a number of units, all of which could include multiple computing units. The processor(s) 901 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 901 is configured to fetch and execute computer-readable instructions and data stored in the memory 903.

The memory 903 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 907 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 907 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 907 when executed by the processor(s) 901 may be configured to perform any of the described functionalities. According to an embodiment, the module 907 includes the configuring module 201, the processing module 203, the identification module 205, and the mapping module 207. In an alternate embodiment, the functions of the aforesaid modules may be performed by the processor(s) 901.

As a further example, the database 905 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 901, and the modules/engines/units 907.

The modules/engines/units 907 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to make a determination or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 909 includes a computer monitor, a touch screen, an output device capable of displaying the graphics, and the like. The display unit 1007 is configured to display visual output in desktops, laptops, and workstations. The display unit 1007 may come in different sizes, resolutions, and types (such as LCD, LED, or OLED).

As a further example, the network interface 911 is configured to provide and establish communication with any electronic device via a public network, private network, or any wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of ordinary skills in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages include, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method for automatically identifying role and access profile of a user based on a textual query, comprising:
configuring a first set of labels, said first set of labels indicates a role assigned to one or more users and each first label is associated with a first feature vector;
configuring a second set of labels, the second set of labels define access profile and each second label is associated with a second feature vector;
mapping each of the second set of labels with one or more first set of labels;
receiving an input, said input being a textual input defining the desired role and access profile of one or more users;
processing the textual input to parse one or more keywords and define vector representation of the one or more keywords;
performing a semantic analysis on the one or more keywords, to determine a contextual relationship between the one or more keywords;
identifying at least one first keyword, from the one or more keywords, which has a vector similarity with at least one first set of labels;
identifying at least one second keyword, from the one or more keywords, which has the vector similarity to the at least one or more second set of labels associated with the first set of labels;
selecting the first set of labels and the second set of labels associated with the first set of labels based on the contextual relationship; and
updating the profile of the one or more users to identify the role and access profile based on the selected first set of labels and one or more second set of labels.

2. The method of claim 1, wherein the first set of labels are configured based on user input, and wherein the second set of labels are configured in accordance with predefined conditions and rules.

3. The method of claim 1, wherein identifying the at least one first keyword from the one or more keywords comprises:
computing a similarity score between the first set of labels and the one or more keywords;
comparing the similarity score with a predefined threshold value; and
identifying the at least one first keyword, from the one or more keywords, which has the vector similarity with at least one first set of labels based on the similarity score above the predefined threshold value.

4. The method of claim 1, wherein identifying at least one second keyword from the one or more keywords, comprises:
computing a similarity score between the second set of labels and the one or more keywords;
comparing the similarity score with a predefined threshold value; and
identifying the at least one second keyword, from the one or more keywords, which has the vector similarity with at least one second set of labels based on the similarity score above the predefined threshold value.

5. The method of claim 1, wherein the semantic analysis is performed by a natural language processing (NLP) techniques.

6. The method of claim 5, wherein determining the contextual relationship between the one or more keywords comprises:
determining, using NLP models, a semantic proximity between the one or more keywords;
obtaining, using NLP models, semantically similar word embeddings along with a semantic score for each of the semantically similar word embeddings based on the determination of the semantic proximity between the one or more keywords; and
determining, using NLP models, the contextual relationship between each of the semantically similar word embeddings based on the semantic score that is closest with each other.

7. The method of claim 1, wherein the contextual relationship is determined based on user's historical data acquired from a plurality of databases, wherein the user's historical data includes at least one of a user selection pattern and user's behavior.

8. The method of claim 1, further comprising:
obtaining a non-functional requirement document from a plurality of databases;
parsing the non-functional requirement document using NLP techniques;
selecting the first set of labels and one or more second set of labels associated with the first set of labels based on a result of parsing the non-functional requirement document; and
updating the profile of the one or more users to identify the role and access profile based on the selected first set of labels and one or more second set of labels.

9. The method of claim 1, further comprising:
providing a recommendation regarding updating of the profile of the one or more users with the identified role and the access profile.

10. A system for automatically identifying role and access profile of a user based on a textual query, the system comprising:
one or more processors;
a memory; and
one or more programs stored in the memory, the one or more programs when executed by the one or more processors, cause the one or more processors to:
configure a first set of labels, said first set of labels indicates a role assigned to one or more users and each first label is associated with a first feature vector;
configure a second set of labels, the second set of labels define access profile and each second label is associated with a second feature vector;
map each of the second set of labels with one or more first set of labels;
receive an input, said input being a textual input defining the desired role and access profile of one or more users;
process the textual input to parse one or more keywords and define vector representation of the one or more keywords;
perform a semantic analysis on the one or more keywords, to determine a contextual relationship between the one or more keywords;
identify at least one first keyword, from the one or more keywords, which has a vector similarity with at least one first set of labels;
identify at least one second keyword, from the one or more keywords, which has the vector similarity to the at least one or more second set of labels associated with the first set of labels;
select the first set of labels and the second set of labels associated with the first set of labels based on the contextual relationship; and
update the profile of the one or more users to identify the role and access profile based on the selected first set of labels and one or more second set of labels.

11. The system of claim 10, wherein the first set of labels are configured based on user input, and wherein the second set of labels are configured in accordance with predefined conditions and rules.

12. The system of claim 10, wherein to identify the at least one first keyword from the one or more keywords, the one or more processors are configured to:
compute a similarity score between the first set of labels and the one or more keywords;
compare the similarity score with a predefined threshold value; and
identify the at least one first keyword, from the one or more keywords, which has the vector similarity with at least one first set of labels based on the similarity score above the predefined threshold value.

13. The system of claim 10, wherein to identify the at least one second keyword from the one or more keywords, the one or more processors are configured to:
compute a similarity score between the second set of labels and the one or more keywords;
compare the similarity score with a predefined threshold value; and
identify the at least one second keyword, from the one or more keywords, which has the vector similarity with at least one second set of labels based on the similarity score above the predefined threshold value.

14. The system of claim 10, wherein the semantic analysis is performed by a natural language processing (NLP) techniques.

15. The system of claim 14, wherein to determine the contextual relationship between the one or more keywords, the one or more processors are configured to:
determine, using NLP models, a semantic proximity between the one or more keywords;
obtain, using NLP models, semantically similar word embeddings along with a semantic score for each of the semantically similar word embeddings based on the determination of the semantic proximity between the one or more keywords; and
determine, using NLP models, the contextual relationship between each of the semantically similar word embeddings based on the semantic score that is closest with each other.

16. The system of claim 10, wherein the contextual relationship is determined based on user's historical data acquired from a plurality of databases, wherein the user's historical data includes at least one of a user selection pattern and user's behavior.

17. The system of claim 10, wherein the one or more processors are further configured to:
obtain a non-functional requirement document from a plurality of databases;
parse the non-functional requirement document using NLP techniques;
select the first set of labels and one or more second set of labels associated with the first set of labels based on a result of parsing the non-functional requirement document; and
update the profile of the one or more users to identify the role and access profile based on the selected first set of labels and one or more second set of labels.

18. The system of claim 10, wherein the one or more processors are configured to:
provide a recommendation regarding updating of the profile of the one or more users with the identified role and the access profile.

19. A non-transitory computer-readable storage medium storing program instructions for performing a root-cause diagnosis of oscillations in a plurality of assets included in an industrial process, the instructions, when executed, perform the steps of:
configuring a first set of labels, said first set of labels indicates a role assigned to one or more users and each first label is associated with a first feature vector;
configuring a second set of labels, the second set of labels define access profile and each second label is associated with a second feature vector;
mapping each of the second set of labels with one or more first set of labels;
receiving an input, said input being a textual input defining the desired role and access profile of one or more users;
processing the textual input to parse one or more keywords and define vector representation of the one or more keywords;
performing a semantic analysis on the one or more keywords, to determine a contextual relationship between the one or more keywords;
identifying at least one first keyword, from the one or more keywords, which has a vector similarity with at least one first set of labels;
identifying at least one second keyword, from the one or more keywords, which has the vector similarity to the at least one or more second set of labels associated with the first set of labels;
selecting the first set of labels and the second set of labels associated with the first set of labels based on the contextual relationship; and
updating the profile of the one or more users to identify the role and access profile based on the selected first set of labels and one or more second set of labels.

20. The non-transitory computer-readable storage medium of claim 19, further comprising:
providing a recommendation regarding updating of the profile of the one or more users with the identified role and the access profile.
